(19) United States
(12) Patent Application Publication
(10) Pub. No.: US 2008/0284253 A1
(43) Pub. Date: Nov. 20, 2008

(54) Switching Unit For Switching a Connection Between a Mains and a Load

(76) Inventors: Willem Herman Stenfert Kroese, Rotterdam (NL); Maximus Andreas Hillhorst, Lunteren (NL)

Correspondence Address: HOFFMANN & BARON, LLP, 6900 JERICHO TURNPIKE, SYOSSET, NY, 11791, US

(21) Appl. No.: 10/522,117

(22) PCT Filed: Jul. 17, 2003
(86) PCT No.: PCT/NL2003/000528

§ 371 Date: Jan. 25, 2007

(30) Foreign Application Priority Data
Jul. 26, 2002 (NL) 1021168

(51) Int. Cl. H02H 3/12

(52) U.S. Cl. 307/131

(57) ABSTRACT

A switching unit for connecting a load to a mains as a function of a demand for a consumption current by the load comprises a mains port for electrically connecting the switching unit to the mains, a load port for electrically connecting the switching unit to the load, a switching element for producing a substantially conductive electrical connection between the mains port and the load port in its closed state and substantially breaking the said electrical connection in its open state. Furthermore, the switching unit comprises current measuring means for measuring a consumption current consumed by the load, and the control means, which are connected to the switching element, are designed to bring the switching element into the open and closed states on the basis of a consumption current measured by means of the current measuring means in an at least temporarily closed state of the switching element. Furthermore, the invention comprises a method for connecting the load to a mains as a function of the demand of a load for a consumption current.

The invention relates to a switching unit for switching a connection between a mains and a load, comprising a mains port for electrically connecting the switching unit to the mains, a load port for electrically connecting the switching unit to the load, a switching element for producing a substantially conductive electrical connection between the mains port and the load port in its closed state and substantially breaking the said electrical connection in its open state, and current measuring means for measuring a consumption current consumed by the load.

Furthermore, the invention relates to a method for switching a connection between a load and a mains, the load being connected to the mains via a switching element for the purpose of producing a substantially conductive electrical connection between the load and the mains in a closed state of the switching element and substantially breaking the said electrical connection in an open state of the switching element.

The invention also relates to an electrical appliance comprising a switching unit of this type and to the use of a switching unit of this type.

Electrical appliances having a no-load state, such as appliances with a mains adapter which are provided with current via the mains adapter or appliances which have a standby function, are known. Examples of such appliances include notebooks, personal computers, battery chargers, halogen lighting, audio and video equipment, electric blankets, printers and other computer peripherals, as well as many other devices. The appliances may be provided with a separate mains adapter for converting a mains voltage from, for example, a grid mains into, for example, a low voltage. It is also possible for the appliances to be provided with an inbuilt power supply and for the appliance to have a standby state in which the appliance is in the no-load state.

One problem is that most electrical appliances of this type consume current even in the no-load state. For example, mains adapters consume current even when the appliance is switched off or when there is no consumer connected to the mains adapter. Even appliances with a standby function continue to consume some current in the standby state. This current consumption which occurs with a load-free mains adapter or in an appliance with a standby function which is in the standby state is also referred to as a no-load consumption. Calculations have shown that 5% to 10% of the electricity consumption of a household is nowadays caused by no-load consumption. Therefore, the no-load consumption unnecessarily increases the energy consumption, which at a global level is associated with an unnecessary contribution to pollution, greenhouse effects, depletion of energy reserves, etc.

WO 93/09584 has disclosed a device for detecting an open circuit on a secondary side of a transformer. A circuit is positioned on a primary side of the transformer and uses a current sensor, such as a Hall sensor or a resistor, to measure a current in a primary winding of the transformer. If a reduced load occurs, this is detected by the current sensor, and a switch then switches off a primary side of the transformer. Then, the switch is blocked by a driver circuit, so that it cannot be switched on again. The device is intended in particular for use with neon lighting comprising a neon tube and is intended to prevent a high build-up of a secondary voltage in the transformer if the neon tube is defective.

The abovementioned device is therefore unsuitable for use with a consumer with a no-load state, since the device, once it has been switched off, is no longer able to detect whether the consumer remains in a no-load state or is to bring back into an operating state at any moment.

It is an object of the invention to reduce the overall energy consumption of an electrical consumer.

To achieve this object, the switching unit according to the invention is characterized in that the switching unit comprises control means which are connected to the switching element, the control means comprising: (a) means for at least temporarily bringing the switching element into its closed state; (b) means for measuring a consumption current consumed by the load in the at least temporarily closed state of the switching element; (c) means for checking the measurement on the basis of a criterion; (d) means for bringing or holding the switching element into or in the open state if the measurement does not satisfy the criterion; and (e) means for bringing or holding the switching element into or in the closed state if the measurement does satisfy the criterion. By measuring a consumption current in the at least temporarily closed state of the switching element, it is possible to detect a demand for consumption current from the load and on this basis to use the criterion to bring the switching element into or hold it in the open and/or closed state, so that the load is then connected to or disconnected from the mains. In the context of the present document, the term mains is to be understood as meaning any desired electrical power supply feature, such as the public electricity grid or a storage battery. The load, which is also referred to as the consumer, may be any desired appliance or combination of appliances, in other words any desired device which consumes electricity. The use of the invention applies to both AC voltage and DC voltage, both on the side of the mains and on the side of the load. The type of voltage and level of the voltage on the mains side may differ from that on the load side.

Preferably, the means mentioned under (c) comprise means for comparing the measured value of the consumption current with a threshold value, and the means mentioned under (e) comprise means for closing the switching element or holding it in the closed state if the measured value of the consumption current is greater than or equal to the threshold value. Therefore, when the switching unit is in the open state, as a result of the switching element being temporarily moved, during a measurement time, into the closed state, it is possible to measure a value for the consumption current consumed by the load. This value is then compared with a threshold value, and if the value is greater than or equal to the threshold value, i.e. if the load is, for example, found to be in an operating state, the switching element can be closed or kept closed. Although current consumption does occur if the switching element is in the closed state during a measurement time, this current consumption will on average be considerably lower than, for example, a no-load consumption of the loads, since the measurement time is preferably relatively short compared to a period of time prior to the measurement time or following the measurement time, during which the switching element is open, and if the steps of bringing the switching element into the closed state and measuring a consumption current during a measurement time are repeated, the measurement time will preferably be relatively short compared to a repetition period time for in each case bringing the switching element into a closed state. For example, if the repetition period time is one period duration of a 50 Hz AC voltage mains, i.e. 20 milliseconds, the measurement time will be relatively short, preferably less or much less than ⅓ of this time, i.e. preferably less than or much less than 6⅔ milliseconds.

Preferably, the means mentioned under (c) comprise means for comparing the measured value of the consumption current with a threshold value, and the means mentioned under (d) comprise means for bringing the switching element into the open state if the measured value of the consumption current is lower than the threshold value. Consequently, when the switching element is in the closed state, the switching element is moved into the open state if, during measurement of the consumption current with the switching element in the closed state during a measurement time, it is found that the current is lower than a threshold value. By measuring the consumption current in the closed state of the switching element, preferably repeatedly using, for example, a repetition frequency, by means of the current measuring means, it is possible for the switching unit to be moved into the open state if the consumption current is found to be below the threshold value a predetermined number of times. As a result of the switching unit only being moved into the open state if the consumption current is lower than the threshold value during a predetermined number of successive occasions, the switching unit is prevented from switching off in the event of a temporary fluctuation in the consumption current, so that, by way of example, it is possible to prevent as yet unstored data in the load from being lost as a result of the switching element being undesirably opened, with voltage being (substantially) removed from the load as a result.

It is preferable for the threshold value to comprise a value for a no-load consumption current of the load. This makes it possible to detect whether the load is in a no-load state. Obviously, the threshold value may also comprise another suitable value.

Preferably, the control means also comprise means for using the current measuring means to measure a consumption current for a load which has been brought into a no-load state, and means for storing the measured value of the consumption current as a no-load consumption current in a memory which is accessible to the switching unit. By bringing the load into a no-load state and bringing the switching element into the closed state and then measuring the consumption current and storing the measured value of the consumption current as a no-load consumption current in a memory which is accessible to the switching unit, it is possible to determine a no-load current for any load. It is therefore possible to use the switching unit for various loads which each have a different no-load consumption current, since the no-load consumption current of the load in question has been determined by measuring it.

The control means preferably comprise means for adding a margin value to the value for the no-load consumption current, making it possible to obtain a tolerance with respect to interference, noise, fluctuations and measurement inaccuracies.

Preferably, the switching unit comprises voltage measuring means for measuring a mains voltage applied to the mains port, the switching element comprises a self extinguishing semiconductor switch, and the control means comprise control pulse generation means for generating a control pulse for the self extinguishing semiconductor switch as a function of an instantaneous value of the mains voltage measured by the voltage measuring means. If the mains provides an AC voltage, the mains voltage, and therefore the consumption current, will periodically present zero crossings which cause the self extinguishing semiconductor switch to stop conducting. By measuring the mains voltage and generating a control pulse as a function of an instantaneous value thereof, it is possible to cause the self extinguishing semiconductor switch, if desired, to remain conducting even in the event of a zero crossing of the mains voltage or consumption current, by generating a control pulse at a suitable time near or during the zero crossing.

Preferably, the control pulse generation means are also designed to generate a repeating pulse train, a repetition frequency of which corresponds to double a repetition frequency of the mains voltage, for the purpose of holding the self extinguishing semi-conductor switch in the closed state. In this way, the self extinguishing semiconductor switch can be held in the closed state with a minimal energy consumption required to actuate the switch, since the switch is only actuated if the switch were to open as a result of a zero crossing, i.e. were to stop conducting.

Preferably, the control pulse generation means are also designed to shorten a pulse duration of the control pulses after the end of a turn-on time starting from the switching element reaching the closed state. After the switching element has been switched on, which is normally associated with a profile of the consumption current and/or a phase difference between the mains voltage and the consumption current, a more stable state will occur in the absence of turn-on transients of this nature, with the result that a time at which the self extinguishing semiconductor switch would stop conducting in the absence of a control pulse can be determined more accurately, so that the pulse duration can also be shortened. This is responsible for further reducing an energy demand for actuating the self extinguishing semiconductor switch. The control pulses preferably have a pulse duration which is shorter than the repetition period time of the AC voltage.

Preferably, the control pulse generation means are designed to generate a control pulse in the open state of the switching element just before a zero crossing of the mains voltage, for the purpose of bringing the switching element into a closed state during a measurement time. In this way, it is possible to keep the measurement time short, since the self extinguishing semiconductor switch, which is moved into the closed state just before the zero crossing, will stop conducting again when the zero crossings occur. This makes it possible to further reduce the energy consumption, since the measurement time required to repeatedly measure the consumption current from the open state of the switching element can be short. In this context, the term short means: shorter than a period of time between two successive zero crossings of the AC voltage.

Preferably, the control means comprise a first and a second supply voltage terminal for creating a supply voltage between these terminals at the control means, the first supply voltage terminal being connected to a terminal of the switching element which is connected to the mains port and the second supply voltage terminal being connected to a terminal of the switching element which is connected to the load port. The current consumed by the control means can therefore be returned to the load. The mains usually provides a voltage which is considerably higher than a voltage which is required to power the control means, and therefore one problem is that supplying electricity to the control means results in a high consumption of energy, since this current is usually returned to the mains by a stabilizing circuit, rectifier circuit or the like, which leads to considerable losses in the said stabilizing circuits or rectifier circuits. This problem is overcome by the abovementioned measure.

Preferably, the switching element comprises a voltage drop element for causing a voltage drop across the switching element in operation when the switching element is in the closed state. If the voltage required to power the control means is higher than a voltage drop across the switching element, it is possible for the voltage drop element to generate a (relatively minor) additional voltage drop, resulting in a voltage difference of sufficient magnitude to power the control means.

Preferably, the switching unit comprises a male plug connector unit for electrically connecting the mains port to a mains wall socket unit, and a female plug connector for electrically connecting the load port to a male plug connector which is connected to the load. This allows the switching unit to be used with existing loads, for example existing electrical appliances, and allows the advantages of the invention to be implemented in existing electrical appliances. It is also advantageous if the switching unit is accommodated in the load.

Preferably, the switching unit comprises a communications port for transmitting data from or to the control means. The switching unit can therefore, for example, be programmed by a user, for example from a data-processing system, such as a personal computer, or, if the communications port comprises a wireless link, can be actuated by means of a remote control, such as for example for a television set. It is also possible to use the communications port to exchange messages in an automated system, such as an automated system in business premises, a house or other residence, such as a home automation system. The communications port may to this end comprise a terminal for connecting the switching unit to a data-processing system.

The method according to the invention is characterized by the steps of: (a) at least temporarily bringing the switching element into the closed state; (b) measuring a consumption current consumed by the load in the at least temporarily closed state of the switching element; (c) checking the measurement against a criterion; (d) bringing or holding the switching element into or in the open state if the measurement does not satisfy the criterion; and (e) bringing or holding the switching element into in the closed state if the measurement does satisfy the criterion.

Preferably, if the switching element is in the open state, step (c) comprises the step of comparing the measured value of the consumption current with a threshold value; and step (e) comprises the step of closing the switching element or holding the switching element in the closed state if the measured value of the consumption current is greater than or equal to the threshold value.

It is preferable for steps (a), (b), (c) and (d) to be repeated if the measured value of the consumption current is lower than the threshold value, so that a measurement is carried out repeatedly in order to investigate whether the consumption current is still lower than the threshold value. In this way, it is possible to achieve a rapid response time, since a change in a state of the load will rapidly manifest itself in a change in the measured consumption current.

Preferably, if the switching element is in the closed state, step (c) comprises the step of comparing the measured value of the consumption current with a threshold value; and step (d) comprises the step of bringing the switching element into the open state if the measured value of the consumption current is lower than the threshold value.

It is preferable for steps (b), (c) and (e) to be repeated if the measured value of the consumption current is greater than or equal to the threshold value for one or more of a predetermined number of repetitions, the switching element being moved into the open state if the measured value of the consumption current is lower than the threshold value for the predetermined number of repetitions. If the consumption current drops to below a value corresponding to the threshold value, the switching element will be moved into the open state if a consumption current which is lower than the threshold value is measured for a predetermined number of optionally successive repetitions. This increases reliability, since the load is only switched off if a value of the consumption current which is lower than the threshold value is measured for a predetermined number of repetitions. This makes the switching-off operation highly insensitive to interference, since a single measurement in which a low value of the consumption current is observed (caused, for example, by an interference or fluctuation) does not immediately cause the switching element to be switched off. The method according to the invention furthermore preferably comprises the steps of comparing the measured value of the consumption current with the value of the no-load consumption current and storing the measured value of the consumption current as a no-load consumption current in a memory which is accessible to the switching unit if the measured value of the consumption current is lower than the no-load consumption current. If the measured value of the consumption current is lower than the no-load consumption current, an incorrect value for a consumption current has clearly been regarded as the no-load consumption current, in which case the load was clearly not in a no-load state at the moment at which the no-load consumption current value was measured. As a result of the lower value of the consumption current then being stored as a no-load consumption current, it is possible to correct an error of this nature.

It is preferable for the method also to comprise the steps of comparing the measured value of the consumption current with a maximum value and opening the switching element if the measured value of the consumption current is greater than the maximum value. This creates an overload protection, since, if it is found that the measured value of the consumption current is above the maximum value, the switching element is opened.

It is preferable for step (b) to be carried out with a repetition period which is an integer multiple of a repetition period of the mains voltage. By in this way carrying out the measurement synchronously with a repetition of the mains voltage, it is possible to prevent errors caused by phase differences.

Preferably, the steps (a) and (b) comprise the steps of repeatedly or continuously measuring an instantaneous value for the mains voltage; closing the switching element between two successive zero crossings of the mains voltage; measuring the consumption current; and opening the switching element. In this way, it is possible for the switching element to be closed just before a zero crossing of the mains voltage, so that a current measurement can be carried out just before a zero crossing, in other words at a relatively low mains voltage level. This has the advantage of further reducing the current consumption, since the currents which will flow through the loads during the measurement time determined in this way are relatively low. If the switching element also comprises a self extinguishing semiconductor switch, it will be possible to effect opening of the switching element as a result of the self extinguishing nature of the semiconductor switch. A further advantage is that, in the event of an overload or, for example, a short circuit, the currents flowing through the switching element during the measurement time just before the zero crossings will be relatively low, with the result that damage to the switching element or other components is less likely.

The invention also comprises the use of the switching unit according to the invention for powering a battery charger. The switching unit allows a standard battery charger which does not provide for a charging current to be switched off when a battery which is to be charged has reached a predetermined charging condition to be used as a more advanced battery charger, since the switching unit, when a current consumed by the battery charger drops, will open the switching element, thus preventing continuous charging of the battery, which is associated with consumption of energy and a reduction in a battery service life. The switching unit can, for example, periodically switch on the battery charger in order in this way to implement what is known as a drip charging mode.

Furthermore, the invention comprises the use of the switching unit according to the invention for providing a supply voltage to and/or interrupting a supply voltage for a load at least one predetermined time. In this way, it is possible to further reduce a current consumed by the load, for example by keeping the connection between the load and the mains which provides the power supply interrupted during a period of time in which no activity is demanded of the load, for example at night, with the result that even the low level of power consumption which is associated with measuring a consumption current in a temporarily closed state of the switching element can be eliminated.

The invention also comprises the use of the switching unit according to the invention for providing a supply voltage to and/or interrupting a supply voltage for a load in response to an external signal. In this way, it is possible to provide an order to the switching unit, and preferably to the control device therein, to close or open the switching element in order to connect the load to the mains which provides a supply voltage to the load by means of an external signal, such as a signal from a remote control, a signal obtained by operation of a touch-sensitive button, a signal transmitted via the mains or a signal from an automated system. The external signal can be fed to the switching unit in various ways, depending on the nature of the signal. For example, a signal which is superimposed on the mains by means of voltage measuring means which are located in the switching element can be detected. It is also possible for a signal from a remote control to be passed to, for example, the control means in the switching unit via a suitable receiver in the switching unit, such as an infrared receiver which is known per se in the case of an infrared remote control. By switching the supply voltage in response to the external signal, it is possible to further reduce a consumption of current in a time period in which no activity is demanded from the load (in other words during a period in which the load will be substantially in the standby state), since by opening the switching element by means of the external signal, periodic closure of the switching element and the associated, albeit low, current consumption can be reduced further. It is also possible for two or more loads which are each connected to a mains via a switching unit according to the invention to be jointly or separately moved into the closed and/or open state via the external signal. There are numerous conceivable applications for this aspect. For example, it is possible for consumers of a mains to be switched simultaneously when a signal is generated, for example in response to a room being left, a time period ending, etc. The signal can be generated by a control device, a remote control, a home automation system or any other device which is known per se. Furthermore, the switching unit according to the invention may be provided with an identification means, such as an identification chip or an identification means integrated in the control device, for the purpose of identifying the switching unit. This makes it possible, for example, for the switching units at a mains (subassembly) to which two or more switching units are connected to be separately or jointly moved into the open and closed state via an external signal, such as a code, transmitted over the mains.

In the use according to the invention of the switching unit, the step of at least temporarily bringing the switching element into the closed state will preferably be omitted if the switching unit has been moved into the open state by means of an external signal and/or at least one predetermined time, so that it is possible to avoid current consumption associated with the optionally periodic closing of the switching element and measurement of a consumption current. It is also possible, with the use according to the invention, to use the switching element with a load such as a television, a video recorder, an espresso-making machine or the like and to activate and deactivate the load with the aid of an (external) signal generated by a remote control, touch-sensitive button or the like. Further properties and advantages of the invention will become clear from the appended drawing, which shows non-limiting exemplary embodiments and in which:

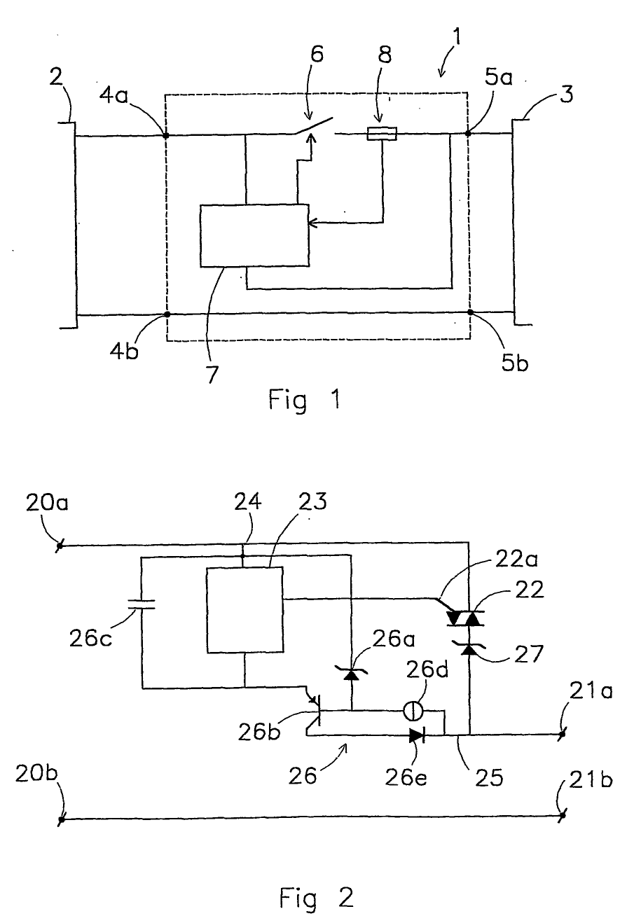

FIG. 1 shows a block diagram of a switching unit according to the invention;

FIG. 2 shows a circuit diagram of the switching unit;

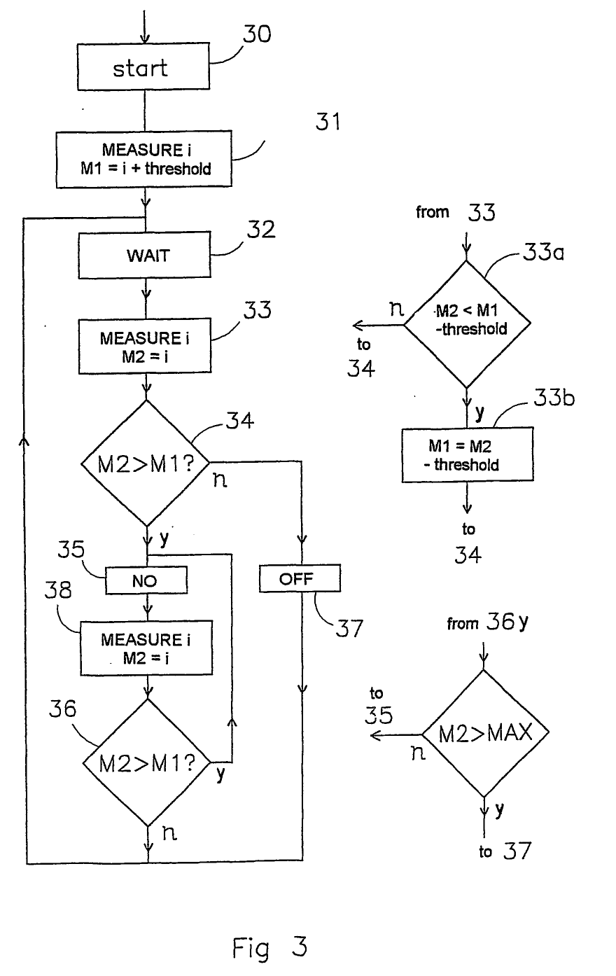

FIG. 3 shows a flow diagram of a method according to the invention; and

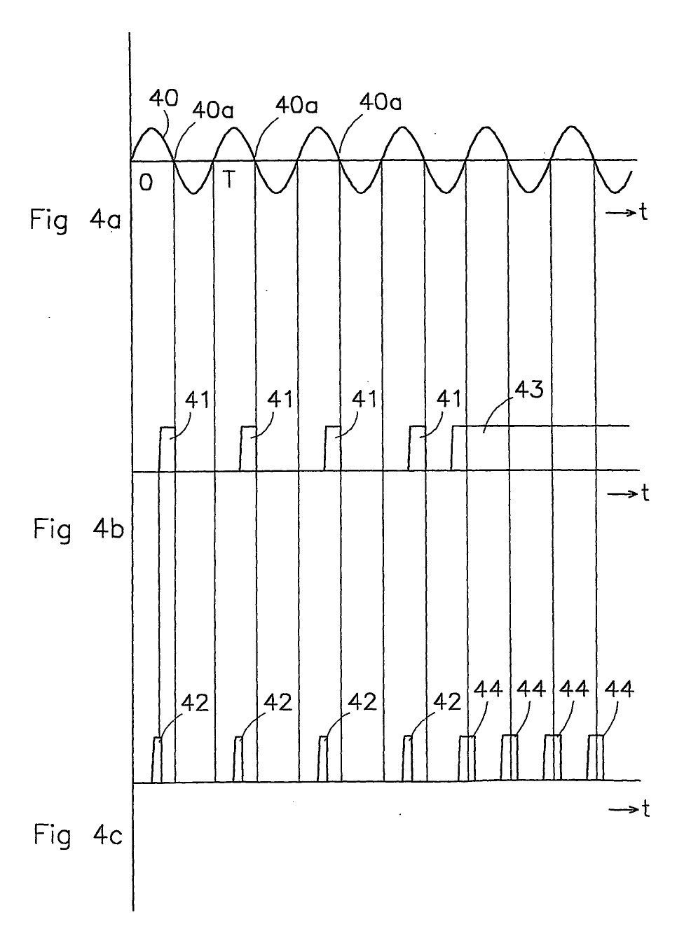

FIGS. 4a-4c show time diagrams illustrating operation of the switching unit.

FIG. 1 shows a switching unit 1 which connects a mains (symbolically indicated by 2) to a load 3. The switching unit comprises a mains port comprising mains terminals 4a, 4b which are electrically conductively connected to the mains, and a load port comprising load terminals 5a, 5b which are electrically conductively connected to the load 3. The switching unit also comprises a switching element 6 for producing an electrically conductive connection between mains terminal 4a and load terminal 5a in the closed, conductive state. The switching unit also comprises control means, such as in this example the control device 7 which is designed to actuate an actuation terminal 6a of the switch. Furthermore, the switching unit comprises current measuring means, symbolically indicated by 8, for measuring a current consumed by the load 3. The mains 2 may comprise any desired electrical power supply connection, such as a connection of a public electricity grid or an on-board voltage supply system of a vehicle and may comprise either DC voltage or AC voltage.

The circuit diagram shown in FIG. 2 shows a switching unit with a mains port comprising mains terminals 20a, 20b, a load port comprising load terminals 21a, 21b, and a switching element 22, in this example a self extinguishing semiconductor switch, such as a TRIAC. The switching element 22 is actuated by control means comprising a control device 23, comprising, for example, a microprocessor. The control means comprise a first supply voltage terminal 24, which is connected to a side of the switching element 22 which is connected to the mains terminal 20a, and a second supply voltage terminal 25, which is connected to a side of the switching element 22 which is connected to load terminal 21a. The switching unit also comprises a stabilizing circuit 26 for providing a stabilized supply voltage to control device 23. The stabilizing circuit 26 comprises a reference diode 26a, such as a zener diode, a buffer transistor 26b, a capacitor 26c, a current source 26d for supplying a setting current to the diode 26a and a protection diode 26e for protecting transistor 26b. In many cases, the mains voltage which is present between the mains terminals 20a, 20b is considerably greater than a mains voltage for the control device 23. The mains voltage may, for example, be of the order of 230 V, if the mains is a public electricity grid. The supply voltage for the control device 23, on the other hand, will usually be of the order of a few V, but at most usually approx. 24 V. By then deriving the supply voltage for the control device 23 from a voltage difference between mains terminal 20a and load terminal 21a, it is possible to generate the required supply voltage for powering the control device 23 with very low electrical losses. This is because in this case it is no longer necessary for the supply current for powering control device 23 to be passed directly to mains terminal 20b via a known stabilizing circuit, in the known way, which entails a low energy efficiency, since the voltage across mains terminals 20a, 20b is generally considerably greater than the voltage which is required to power the control device 23. As a result of the second power supply terminal therefore being connected not to the second mains terminal 20b but rather to a terminal of the switching element 22 which is connected to load terminal 21a, it is possible to improve the efficiency for generation of the supply voltage for control device 23. A further advantage is that if no load is connected to load terminals 21a, 21b, the device shown does not consume any energy at all. The configuration shown therefore also ensures that a supply voltage for the control device is automatically switched off if there is no load connected between the load terminals 21a, 21b.

The switching element is actuated by the control device 23 via a control input 22a. Furthermore, in this exemplary embodiment, a voltage drop element 27 which causes a relatively minor additional voltage drop between mains terminal 20a and load terminal 21a is incorporated in series with the switching element 22. The result of this is that, even at a very low consumption current uptake by a load connected to load terminals 21a, 21b, there is a sufficient voltage drop between mains terminal 20a and load terminal 21a to generate a supply voltage for control device 23. The voltage drop element 27 may, for example, comprise a zener diode. Of course, it will be clear that, if there is a sufficient voltage drop across switching element 22 to generate a supply voltage for control device 23, there is no need to incorporate a voltage drop element 27 in series with switching element 22, and therefore voltage drop element 27 can be omitted and replaced by a conductive connection. The control device 23 may, for example, comprise a microprocessor or microcontroller. The switching unit shown in FIG. 2 is also provided with current measuring means (not shown), such as for example a current measuring resistor which can be positioned in series with the switching element 22 for the purpose of measuring a consumption current of a load connected to load terminals 21a, 21b, which current runs from mains terminal 20a via the switching element 22 to load terminal 21a. The current measuring means may, of course, alternatively comprise other current measuring means which are known per se. The switching unit may also be provided with voltage measuring means (not shown) for measuring a mains voltage connected to mains terminals 20a, 20b. The voltage measuring means may, for example, comprise a voltage divider, comprising two high-value resistors which are connected in series between mains terminal 20a and mains terminal 20b, with a connecting point between the two resistors being connected to the control device 23. The current measuring means and voltage measuring means may, for example, be connected to an analogue input of the control device 23, in which case analogue measured values can be converted into a digital value by an analogue/digital converter which is known per se.

The operation of the switching units shown in FIG. 1 and FIG. 2 will be explained with reference to FIG. 3 and FIG. 4. As shown in FIG. 3, after the device has been started, as indicated by step 30, the current will be measured during a measurement time in step 31. For this purpose, the switching element is closed during the measurement time. To carry out step 31, the load has been moved into a no-load state, so that the measured current corresponds to the no-load current. Then, a margin value is added to the measured current in step 31, and the value determined in this way is stored in a memory denoted by M1. This is followed by waiting for a certain time, as indicated by step 32. During this waiting period, the switching element is in the open state. Then, in step 33, the current is measured again by closing the switching element and keeping it closed for a measurement time, and the measured current is stored in a second memory denoted by M2. Then, step 34 tests whether the measured current, a value for which is stored in M2, is greater than the value stored in M1, which represents the no-load current with a margin value added to it. If this is not the case, the load is clearly still in the no-load state and, as indicated in step 37, the switching element is kept in the open state, i.e. kept in the off state. The method then returns to step 32, which again involves waiting for a defined time, after which steps 33 and 34 are repeated. As long as the consumer remains in the no-load state, the value which has been measured and stored in memory site M2 will be lower than the values stored in M1, meaning that the loop comprising steps 32, 33, 34 and 37 will be constantly repeated. In the process, in step 33 the switch is in each case closed for the measurement time before then being opened again. The period of waiting time in step 32 determines a repetition frequency for carrying out the current measurement.

If the load shows an increased demand for consumption current at any time when step 33 is being carried out and the uptake of consumption current during the measurement time is measured and stored in M2, a higher value for the consumption current will be recorded and stored in M2. If this value is sufficiently high, in step 34 it will be detected that M2 is greater than M1, so that in step 35 the switching element is then switched on. This will then involve passing through a loop comprising steps 35, 38 and 36 for as long as the measured current consumption is greater than the value determined by M1. After the switching element has been moved into the closed state in step 35, in step 38 the current consumption is measured and stored in M2. Then, in step 36 a comparison is performed between the value stored in M1 and the values which have been measured and stored in M2, and as long as M2 is greater than M1 the method returns to step 35. Obviously, it is possible to add a waiting step into this loop comprising steps 35, 38 and 36, for example between step 35 and step 38, so that this loop is not passed through continuously, but rather with a waiting time in-between. If, in step 38, a low value for the consumption current is then measured and stored in M2, on account of the consumer having returned to a no-load state, the method will return to step 32 from step 36. Then, the succession of steps described above starting with step 32 will be passed through. It is also possible to incorporate a counter step in the loop comprising steps 35, 38 and 36, returning from step 36 to step 35, which counter step will be known per se to a person skilled in the art, in order to ensure that the above-mentioned loop is only left if the measured value for the consumption current is lower than the threshold value determined by M1 for a predetermined number of times. In this way, it is possible to increase reliability, since the load is not switched off immediately in the event of a one-off interference or, for example, a single incorrect measurement. If, as described, the loop comprising steps 35, 38 and 36 is left as a result of a use current which is lower than the value stored in M1 being detected once (or a predetermined number of times), the method will pass through steps 32 and 33, after which step 34 will again detect that the measured value is lower than the threshold value stored in M1 (assuming that a low consumption current which is below the threshold value is indeed still measured), so that then in step 37 the switching element is moved to the off state, i.e. into the open state. If it is desired for the switching element to be opened, i.e. switched off, directly from the abovementioned loop comprising the steps 35, 38 and 36 when it is found that the consumption current measured and stored in M2 is no greater than the threshold value stored in M1, it is possible, after leaving step 36 by the exit indicated by N, to incorporate an additional step in which the switching element is switched off, i.e. opened.

In order to detect errors in the determination of the value stored in M1, i.e. errors in the determination of the no-load consumption current value and the margin value added to it, it is possible, for example, to incorporate a number of additional steps between steps 33 and 34. For example, it would be possible, in step 33a, to detect whether the value which has been stored in M2 and corresponds to the consumption current which has just been measured in step 33 is lower than the value stored in M1 minus the margin value. If this is not the case, the method will then continue normally with step 34, but if this is the case, this means that a consumption current which is lower than the no-load consumption current has been detected. This consumption current, which has been stored in M2, can then be used in step 33b to determine a new value M1 by adding the margin value to the measured consumption current stored in M2 and storing this new total in M1. A new, lower value for M1 has now been stored, based on the measured, lower value of the consumption current. Then, after step 33b has been carried out, it is possible to continue with the above-described step 34. The steps 33a and 33b shown can therefore also be inserted between the steps 33 and 34.

Similarly to the introduction of steps 33a and 33b between step 33 and 34, it is also possible to introduce additional steps, in which case the measured value of the consumption current is compared with a maximum value and the switching element is opened if the measured value of the consumption current is greater than the maximum value. This allows an overload protection to be implemented. Steps of this nature can be introduced, for example, after step 36, specifically after the exit of step 36 indicated by letter Y, in which case in step 36a the measured value of the consumption current which has been stored in M2 is compared with a maximum value, and if the consumption current is no greater than the maximum value, the method continues with step 35, and therefore the switch is held in the closed state, whereas, if the comparison carried out in step 36a shows that the measured value stored in M2 is greater than the maximum value, the method brings on to step 37 and the switching element is moved into the off state, i.e. the open state.

In this way, the method passes through measurement cycles in which the switching element is either in the closed state, with the consumption current being measured each time, or in an open state and being closed for a measurement time in order to measure the demand for consumption current. If the mains voltage comprises an AC voltage, it is possible to make a repetition frequency for execution of the measurements identical to a frequency of the AC voltage or to a subharmonic thereof. This can be achieved by suitably selecting the waiting times, so that a cycle comprising a waiting time and a measurement time and any time required to carry out other steps is equal to one period duration of the AC voltage or to a multiple of this period duration. A waiting time which is introduced into the loop comprising the steps 35, 38 and 36 can be dimensioned in a similar way to the operation of dimensioning a waiting time in step 32 as described above. The result of this is that repeated measuring of the value of the consumption current consumed by the load takes place with a repetition period which is an integer multiple of a repetition period of the mains voltage.

FIG. 4 shows a graph which on the horizontal axes plots the time, FIG. 4a representing a curve of a mains voltage, i.e. an AC voltage, FIG. 4b represents whether the switching element is closed or open, and FIG. 4c represents control pulses for actuating the switch. As is shown, the AC voltage may have a sinusoidal waveform, but the AC voltage may also take any other periodic waveform. The time axes in FIGS. 4a, 4b and 4c correspond to one another, meaning that positions which are vertically in line with one another along the horizontal axes of the figures in question represent the same time. As indicated by 41, the switching element is in each case closed during a measurement time for the purpose of measuring a value of the consumption current consumed by the load. The measurement time is short compared to a repetition period of the AC voltage, which corresponds to a time duration from 0 to T. The measurement time 41 during which the switching element is closed in each case begins just before a zero crossing 40a of the mains voltage 40. One advantage of this is that low current will flow during the measurement time, since the instantaneous values of the AC voltage signal 40 are low compared to a top value thereof during the measurement time. As indicated in FIG. 4c, at the start of the measurement time 41, a control pulse 42 is in each case generated for the purpose of making the switching element conductive, i.e. bringing it into the closed state. In this example, the switching element comprises a self extinguishing semiconductor switch, such as a TRIAC, as has also been described with reference to FIG. 2, so that the switching element will switch off at a first zero crossing of a current flowing through the switching element. This zero crossing will correspond to a zero crossing 40a of the mains voltage or will deviate slightly from this as a result of a phase difference. In any event, the switching element, after having been closed by means of the control pulse 42, will automatically be turned off and as a result returned to the open state. In order to enable the time of a zero crossing 40a to be determined, it is possible for the switching unit shown in FIG. 2 to be provided with voltage measuring means for measuring an instantaneous value of the mains voltage. The control means, or more particularly the control pulse generation means, can then start to generate the control pulse 42 as a function of the instantaneous value of the mains voltage measured by means of the voltage measuring means.

As is shown, it is possible to carry out the closing of the switching element during the measurement time 41 with the same repetition frequency as the repetition frequency of the AC voltage mains signal. It is also possible to carry out the closing of the switching element during the measurement time 41 with pauses amounting to a multiple of the period duration T of the AC voltage.

If, at a given moment, the consumption current measured during the measurement time 41 is greater than the no-load consumption current together with any margin value which may have been added to it, the switching element will be moved into a closed state, as indicated by 43. As shown in this example, the movement into the closed state may take place around a subsequent zero crossing which follows the end of the measurement time, although it is also possible for the movement into the closed state to take place earlier, i.e. for example following the measurement time in question, or later, for example one or more period durations of the AC voltage signal later. The control pulse generation means will now generate a repeating control pulse train, a repetition frequency of which corresponds to double a repetition frequency of the mains voltage, so that the self extinguishing semiconductor switch is held in the closed state. The repeating control pulse train is indicated by pulses 44. Since a control pulse 44 is in each case generated around a zero crossing, the self extinguishing semiconductor switch will remain in the conductive state, since at each zero crossing of the current flowing through the self extinguishing semiconductor switch, this switch is held in the conductive state by a subsequent control pulse 44. Furthermore, the control pulse generation means are preferably designed to shorten a pulse control of the control pulses after the end of a turn-on time starting from the switching element bringing into the closed state. After all, after a few turn-on transients, any phase difference between the mains voltage 40 and the consumption current will have a substantially constant value, so that the control means are able to accurately predict the zero crossings of the consumption current and the control pulse generation means can accurately couple a time for starting the pulses 44 to this zero crossing.

As an alternative or in addition to the embodiments described above, many further advantageous embodiments are also possible, a number of which will be discussed below.

In one embodiment, the switching unit (for example for cost saving) comprises at least two load ports for connecting a load to each load port, in which case the at least two load ports can be actuated by a common control unit. In this embodiment, each load port can be provided with separate current measuring means and a separate switching element, so that each load which is connected to a respective load port is switched on and off separately as a function of its current consumption (in which case the threshold value for each of the load ports can be determined separately by the control device), although it is also possible for two or more, or groups of two or more of the load ports to be provided with a common switching unit and/or common current measuring means. This allows groups of at least two load ports to be switched on and off simultaneously. If a plurality of load ports are provided with common current measuring means, it is possible for the current measuring means to measure a consumption current on a single one of the load ports, but it is also possible for the current measuring means to measure the consumption current at least two of the load ports alternately or simultaneously.

As a variant to the embodiments described above, it is also possible for the control means to switch one or more switching elements likewise as a function of a further signal, such as a signal from a touch-sensitive button, an infrared (IR) or radio-frequency (RF) remote control, or any other suitable signal, such as a change in a measurement impedance, measurement capacitance, measurement induction, etc. By way of example, it is possible for the control unit to switch off the load ports if the current consumed by the load is below a threshold value, while the load ports can be switched on by means of the external signal. For example, a user could switch on a television set connected to a load port using a remote control, while the switching unit only switches off the set if the consumption current has dropped below the threshold value. It is also conceivable for the control unit to store the further signal and, after (all or some of) the load ports have been switched off by means of the further signal, to detect which of the load ports are actually showing an increase in current consumption which is such that the appliances connected thereto have clearly been switched into the operating state, and to couple the type (such as the code) of the stored further signal by means of the control unit to the corresponding load ports which have shown an increase in consumption current, so that during a subsequent switching-on operation with the same type of the further signal, only these load ports are switched on. This makes the switching unit self-teaching, since the switching unit, once a type of the further signal is known, only switches on those load ports for which it has been found that the consumer connected thereto will actually be switched into an operating state with this type of the further signal. This also prevents other consumers from being switched on unnecessarily. Furthermore, the switching unit can switch off those load ports for which the consumer connected thereto has not been switched into the operating state, for example within a predetermined time after activation by means of the further signal. It is also possible for the switching unit to switch off one or more of the consumers if these consumers, at a given moment during a predetermined minimum time duration, have a current consumption which is lower than the threshold value. The further signal can be received, for example, by a receiver unit, such as an IR receiver which may be positioned in the vicinity of one of the appliances which are connected to the load ports, for the purpose of receiving signals from a remote control associated with one or more of the appliances. Furthermore, it is possible for one or more of the load ports to be switched on or off directly or with a predetermined delay, depending on the type of the further signal.

As a further variant to the embodiments given above, it is possible for an indication of a nature of a consumer to be connected thereto to be arranged at each of the load ports. This makes it possible for each of the load ports to be optimally matched to the particular consumers in terms of their properties (maximum load, forms of groups of load ports, repetition frequency for measurement of a current consumption, optional switching as a function of the further signal, etc.) and thereby to anticipate the particular type of consumer.

In addition to and/or in combination with the embodiments described above, it is also possible, further to the description shown in FIG. 4 and associated with FIG. 4, for the switching element to be switched on gradually, so that high turn-on currents can be avoided, as will be explained below.

In the case of switching on with an AC voltage mains, first of all the switching element is closed for part of a period duration of the AC voltage, specifically just before the voltage passes through zero, and is then opened again. Since the voltage is lower that time, a relatively limited current is flowing. During the subsequent periods of the AC voltage, the switching element is each time closed for a slightly longer time, for example as a result of the switching element being switched on slightly earlier each time within the period of the AC voltage, until after a number of times the switching element remains closed (switched on) throughout the entire period duration. In the case of a self extinguishing semiconductor switch, the switching-off operation is in each case simple to implement, since this, as described above, takes place automatically at the zero crossing of the AC voltage signal, i.e. in the case of a switch of this type, it is merely necessary in each instance to provide a signal to switch on at the desired moment within the period duration of the AC voltage. One advantage of this gradual switching on is that the turn-on currents are low, which is a considerable advantage if the load, for example, includes a capacitor (for example in the case of a switched power supply), which first of all has to be charged up to a certain voltage before it starts to operate. Even in the case of an inductive load, it is advantageous to limit the turn-on current, since the inductive load could burn out if an excessively high turn-on current occurs excessively often. Since, in the case of the switching unit according to the invention, the switching-on operation takes place periodically and generally a large number of times, specifically in order in each case to determine whether the load satisfies the criterion (for example exceeding a threshold value), the abovementioned advantages of switching on gradually are considerable.

As an alternative to measuring a current through the load, it is also possible to measure an impedance of the load instead of measuring the current through the load. This makes it possible to achieve the same advantages as those described above in connection with the measure of switching on gradually.

In a first variant, which can be used, for example, for power supplies for halogen lamps and doorbells, the current measuring means comprise a resistor with a particularly high value, such as 10 kOhm, for applying the mains voltage to the load via the resistor. The resistor which, when the switching element is closed, is arranged in series with the load, means that the current through the load is relatively low. Then, when the switching element is closed, the impedance of the load is measured by the control unit, and if this satisfies a specific criterion, the voltage can be switched on completely (i.e. without the resistor connected in series), whereas otherwise it has to be switched off again until the next periodic measurement of the impedance.

In a second variant, which can be used, for example, for appliances (loads) which are only activated if the instantaneous value of the supply voltage connected to them exceeds a threshold value, the current through the load with a semiconductor element (such as a transistor or field-effect transistor) can be gradually increased to the level at which an impedance can be measured by the control unit. Similarly to the first variant, the impedance of the load is then measured, and if this satisfies a specific criterion, the voltage can be switched on completely (i.e. without limiting the current by means of a semiconductor element), whereas otherwise it has to be switched off again until the next periodic measurement of the impedance. This second variant is advantageous, for example, if the load comprises a battery charger, since a battery charger will in general only switch on if the instantaneous value of the supply voltage connected to it exceeds a certain minimum value.

It will be clear that the switching unit and the method according to the invention can be used with a wider variety of loads, i.e. electrical consumers, so that the advantages of the invention, including the reduction of a consumption current consumed by the load, can be realized in combination with a wide range of appliances.

1. Switching unit for switching a connection between a mains and a load, comprising:
a mains port for electrically connecting the switching unit to the mains,
a load port for electrically connecting the switching unit to the load,
a switching element for producing a substantially conductive electrical connection between the mains port and the load port in its closed state and substantially breaking the said electrical connection in its open state, and
current measuring means for measuring a consumption current consumed by the load, wherein the switching unit comprises control means which are connected to the switching element, the control means comprising:
(a) means for at least temporarily bringing the switching element into its closed state;
(b) means for measuring a consumption current consumed by the load in the at least temporarily closed state of the switching element;
(c) means for checking the measurement on the basis of a criterion;
(d) means for bringing or holding the switching element into or in the open state if the measurement does not satisfy the criterion; and
(e) means for bringing or holding the switching element into or in the closed state if the measurement does satisfy the criterion.

2. Switching unit according to claim 1, wherein the means mentioned under (c) comprise means for comparing the measured value of the consumption current with a threshold value, and the means mentioned under (e) comprise means for closing the switching element or holding it in the closed state if the measured value of the consumption current is greater than or equal to the threshold value.

3. Switching unit according to claim 1, wherein the means mentioned under (c) comprise means for comparing the measured value of the consumption current with a threshold value, and
the means mentioned under (d) comprise means for bringing the switching element into the open state if the measured value of the consumption current is lower than the threshold value.

4. Switching unit according to claim 2, wherein the threshold value comprises a value for a no-load consumption current.

5. Switching unit according to claim 4, wherein the control means also comprise:
means for using the current measuring means to measure a consumption current for a load which has been brought into a no-load state, and means for storing the measured value of the consumption current as a no-load consumption current in a memory which is accessible to the switching unit.

6. Switching unit according to claim 5, wherein the control means comprise means for adding a margin value to the value for the no-load consumption current.

7. Switching unit according to claim 1, wherein the switching unit comprises voltage measuring means for measuring a mains voltage applied to the mains port, in that the switching element comprises a self extinguishing semiconductor switch, and in that the control means comprise control pulse generation means for generating a control pulse for the self extinguishing semiconductor switch as a function of an instantaneous value of the mains voltage measured by the voltage measuring means.

8. Switching unit according to claim 7, wherein the control pulse generation means are also designed to generate a repeating pulse train, a repetition frequency of which corresponds to double a repetition frequency of the mains voltage, for the purpose of holding the self extinguishing semi-conductor switch in the closed state.

9. Switching unit according to claim 8, wherein the control pulse generation means are also designed to shorten a pulse duration of the control pulses after the end of a turn-on time starting from the switching element reaching the closed state.

10. Switching unit according to claim 7, wherein the control pulse generation means are designed to generate a control pulse in the open state of the switching element just before a zero crossing of the mains voltage, for the purpose of bringing the switching element into a closed state during a measurement time.

11. Switching unit according to claim 10, wherein the control means comprise a first and a second supply voltage terminal for creating a supply voltage between these terminals at the control means, the first supply voltage terminal being connected to a terminal of the switching element which is connected to the mains port and the second supply voltage terminal being connected to a terminal of the switching element which is connected to the load port.

12. Switching unit according to claim 11, wherein the switching element comprises a voltage drop element for causing a voltage drop across the switching element in operation when the switching element is in the closed state.

13. Switching unit according to claim 12, wherein the switching unit comprises a male plug connector unit for electrically connecting the mains port to a mains wall socket unit, and a female plug connector for electrically connecting the load port to a male plug connector which is connected to the load.

14. Switching unit according to claim 13, wherein the switching unit is accommodated in the load.

15. Switching unit according to claim 14, wherein the switching unit comprises a communications port for transmitting data from or to the control means.

16. Switching unit according to claim 15, wherein the communications port comprises a wireless connection.

17. Switching unit according to claim 15
wherein the communications port comprises a terminal for connecting the switching unit to a data-processing system.

18. Electrical appliance comprising a switching unit according to claim 1.

19. Method for switching a connection between a load and a mains, the load being connected to the mains via a switching element for the purpose of producing an electrical connection between the load and the mains in a closed state of the switching element and substantially breaking the said electrical connection in an open state of the switching element, comprising the steps of:
(a) at least temporarily bringing the switching element into the closed state;
(b) measuring a consumption current consumed by the load in the at least temporarily closed state of the switching element;
(c) checking the measurement against a criterion;
(d) bringing or holding the switching element into or in the open state if the measurement does not satisfy the criterion; and
(e) bringing or holding the switching element into or in the closed state if the measurement does satisfy the criterion.

20. Method according to claim 19, wherein, if the switching element is in the open state,
step (c) comprises the step of
comparing the measured value of the consumption current with a threshold value; and
step (e) comprises the step of
closing the switching element or holding the switching element in the closed state if the measured value of the consumption current is greater than or equal to the threshold value.

21. Method according to claim 20, comprising repeating steps (a), (b), (c) and (d) if the measured value of the consumption current is lower than the threshold value.

22. Method according to claim 19, wherein, if the switching element is in the closed state, step (c) comprises the step of comparing the measured value of the consumption current with a threshold value; and step (d) comprises the step of
bringing the switching element into the open state if the measured value of the consumption current is lower than the threshold value.

23. Method according to claim 22, comprising repeating steps (b), (c) and (e) if the measured value of the consumption current is greater than or equal to the threshold value for one or more of a predetermined number of repetitions, the switching element being moved into the open state if the measured value of the consumption current is lower than the threshold value for the predetermined number of repetitions.

24. Method according to claim 20, wherein the threshold value comprises a value of a no-load consumption current.

25. Method according to claim 24, wherein the method comprises the initial steps of:
(f) bringing the load into a no-load state;
(g) bringing the switching element into the closed state;
(h) measuring the consumption current;
(i) storing the measured value of the consumption current as a no-load consumption current in a memory which is accessible to the switching unit.

26. Method according to claim 25, wherein step (i) also comprises the step of:
adding a margin value to the value of the no-load consumption current.

27. Method according to claim 24, wherein the method also comprises the steps of:
comparing the measured value of the consumption current with the value for the no-load consumption current;
storing the measured value of the consumption current as a no-load consumption current in a memory which is accessible to the switching unit if the measured value of the consumption current is lower than the no-load consumption current.

28. Method according to claim 19, wherein the method also comprises the steps of:
comparing the measured value of the consumption current with a maximum value; and opening the switching element if the measured value of the consumption current is greater than the maximum value.

29. Method according to of claim 20, wherein step (b) takes place with a repetition period which is an integer multiple of a repetition period of the mains voltage.

30. Method according to claim 20, wherein the steps (a) and (b) comprise the steps of:
repeatedly or continuously measuring an instantaneous value for the mains voltage;
closing the switching element between two successive zero crossings of the mains voltage;
measuring the consumption current; and
opening the switching element.

31. Use of the switching unit according to claim 1 for powering a battery charger.

32. Use of the switching unit according to claim 1 for providing a supply voltage to and/or interrupting a supply voltage for a load at least one predetermined time.

33. Use of the switching unit according to claim 1 for providing a supply voltage to and/or interrupting a supply voltage for a load in response to an external signal.
